(19) United States
(12) Patent Application Publication
(10) Pub. No.: US 2018/0315295 A1
(43) Pub. Date: Nov. 1, 2018

(54) SYSTEMS AND METHODS FOR REDUCING A DECIBEL OR VOLUME LEVEL OF AN ALARM SOUND EMITTED BY AN ALARM SYSTEM OR A SECURITY SYSTEM

(71) Applicant: Honeywell International Inc., Morristown, NJ (US)

(72) Inventor: Brian Craig Peterson, Barrington, IL (US)

(21) Appl. No.: 15/946,014

(22) Filed: Apr. 5, 2018

Related U.S. Application Data
(60) Provisional application No. 62/491,026, filed on Apr. 27, 2017.

(51) Int. Cl. G08B 25/00; G08B 3/10

(52) U.S. Cl. CPC G08B 25/008; H04R 2430/01; G08B 3/10

(57) ABSTRACT

Systems and methods for reducing the decibel or volume level of an alarm sound emitted by an alarm system or a security system from a first volume level to a second volume level are provided. Some methods can include detecting a user at a control panel of the security system when an audio alarm is broadcasting the audio sound at the first volume level, the control panel determining whether the user is attempting to use the control panel to disarm the security system, and when the control panel determines that the user is attempting use the control panel to disarm the security system, lowering the first volume level to the second volume level.

### CROSS-REFERENCE TO RELATED APPLICATIONS

This application claims priority to U.S. Provisional Patent Application No. 62/491,026 filed Apr. 27, 2017 and titled “SYSTEMS AND METHODS FOR REDUCING THE DECIBEL LEVEL OF AN ALARM EMITTED BY AN ALARM SYSTEM.” U.S. Application No. 62/491,026 is hereby incorporated herein by reference.

### FIELD

The present invention relates generally to alarm systems. More particularly, the present invention relates to systems and methods for reducing a decibel or volume level of an alarm sound emitted by an alarm system or a security system.

### BACKGROUND

When an alarm device is triggered in a known alarm system, an alarm sound emitted is very loud and can be on the order of 90 dB or higher, which can be painful to a user within range of the alarm sound, especially a user located proximate a control panel of the alarm system. However, many alarms in known alarm systems are false alarms. Accordingly, while the alarm sound is being emitted, the user may approach the control panel of the alarm system to disable or disarm the alarm system, but the loudness of the alarm sound at the control panel may cause increased stress to the user and lead to more user errors.

In view of the above, there is a continuing, ongoing need for improved systems and methods.

### BRIEF DESCRIPTION OF THE DRAWINGS

FIG. 1 is a block diagram of an alarm system or a security system in accordance with disclosed embodiments; and

FIG. 2 is a flow diagram of a method in accordance with disclosed embodiments.

### DETAILED DESCRIPTION

While this invention is susceptible of an embodiment in many different forms, specific embodiments thereof will be described herein in detail with the understanding that the present disclosure is to be considered as an exemplification of the principles of the invention. It is not intended to limit the invention to the specific illustrated embodiments.

Embodiments disclosed herein can include systems and methods for reducing a decibel or volume level of an alarm sound emitted by an alarm system or a security system from a first level to a second level that can improve a user experience and reduce user error when disabling or disarming the alarm system or the security system.

In some embodiments, a control panel of the alarm system or the security system can include a camera that can recognize an identified user proximate the control panel and/or that can recognize that the identified user is attempting to use the control panel or a user interface of the control panel, for example, to disable or disarm the alarm system or the security system. For example, in some embodiments, the camera can recognize that the identified user is an authorized user, such as a household member, and not an unauthorized user, such as a potentially nefarious party. In some embodiments, to recognize that the identified user is the authorized user, the control panel can compare an image captured from the camera to stored images of authorized users of the alarm system or the security system. Additionally or alternatively, in some embodiments, to recognize that the identified user is the authorized user, the control panel can use low quality facial recognition or can match other distinct characteristics of the authorized user, such as height and body type. It is to be understood that the control panel can use a low quality matching system that does not identify a detailed, exact match, but that saves time and computing resources to recognize that the identified user is the authorized user because the control panel does not disable or disarm the alarm system or the security system responsive to recognizing that the identified user is the authorized user.

In some embodiments, the camera can include a passive infrared (PIR) camera that can recognize a presence of the identified user within a predetermined distance thereof. In these embodiments, responsive to recognizing that the identified user is the authorized user and responsive to identifying that the identified user is within a predetermined distance of the camera and, therefore, the control panel, the control panel can reduce the decibel or volume level of the alarm sound emitted from the first level to the second level, which can be lower than the first level. In some embodiments, the alarm sound can be emitted at the second level for a predetermined period of time, and in some embodiments, the alarm sound can be emitted at the second level until the identified user disables or disarms the alarm system or the security system, thereby allowing the identified user to disable or disarm the alarm system or the security system in a manner that is less stressful than doing so while the alarm sound is emitted at the first level.

In some embodiments, responsive to the user interface of the control panel receiving a first user input, for example, a first press on a touchscreen as the identified user proximate the control panel attempts to disable or disarm the alarm system or the security system, the control panel can reduce the decibel or volume level of the alarm sound emitted from the first level to the second level. In some embodiments, the alarm sound can be emitted at the second level for a predetermined period of time, and in some embodiments, the alarm sound can be emitted at the second level until the identified user disables or disarms the alarm system or the security system, thereby allowing the identified user to disable or disarm the alarm system or the security system in a manner that is less stressful than doing so while the alarm sound is emitted at the first level.

In some embodiments, the control panel can temporarily reduce the decibel or volume level of the alarm sound emitted from the first level to the second level responsive to recognizing any generic user proximate or within the predetermined distance of the control panel, for example, via the camera or via received user input. If the control panel fails to recognize the generic user as the authorized user within a predetermined period of time, for example, by receiving a valid pin code associated with the authorized user, then the control panel can determine that the generic user is an unauthorized nefarious party and can increase the decibel or volume level of the alarm sound emitted back to the first level.

In some embodiments, after the control panel reduces the alarm sound emitted to the second level, if the alarm system or the security system fails to be disabled or disarmed within a predetermined period of time thereof, then the control panel can increase the alarm sound emitted back to the first level.

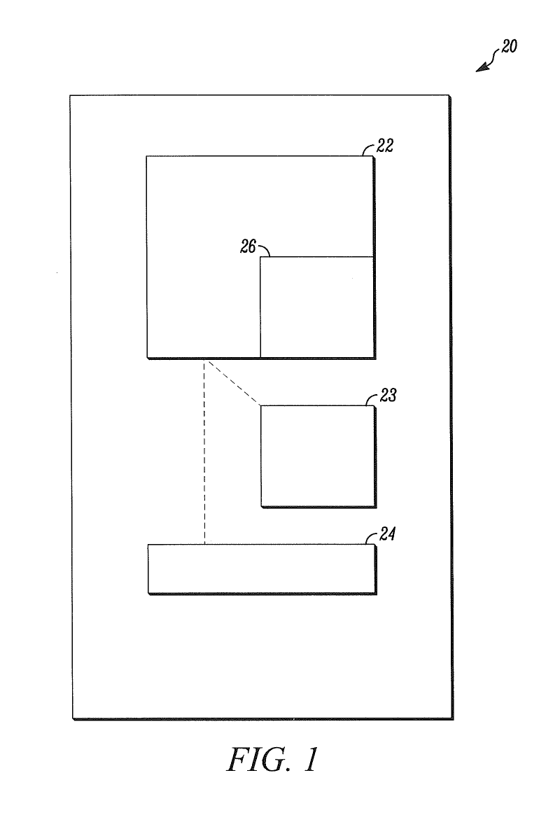

FIG. 1 is a block diagram of an alarm system or security system 20 in accordance with disclosed embodiments. The alarm system or security system 20 can include a control panel 22, a camera or sensor 23, and an alarm sounder 24. The camera or sensor 23 and the alarm sounder 24 can communicate with the control panel 22 via a wireless or wired communications medium. The control panel 22 can include a user interface 26 for use in disarming the alarm system or security system 20 and deactivating the alarm sounder 24. In some embodiments, the camera or sensor 23 can include a passive infrared camera or sensor that can detect a presence of an identified user proximate or within a predetermined distance of the control panel 22.

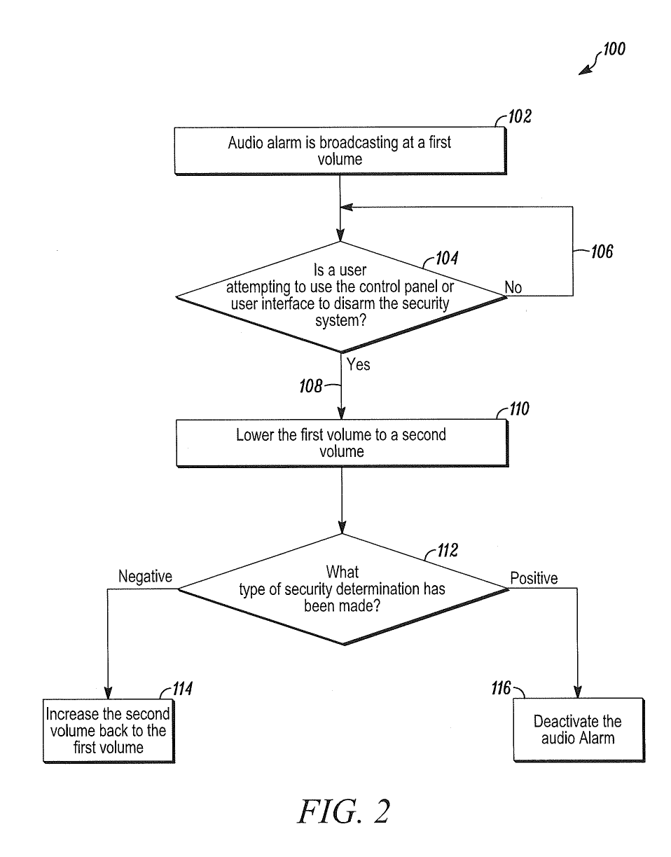

FIG. 2 is a flow diagram of a method 100 in accordance with disclosed embodiments. The alarm system or security system 20 may be in an active alarm mode with the alarm sounder 24 broadcasting an alarm sound at a first volume level, as in 102. The control panel 22 may determine whether the identified user is attempting to use the control panel 22 or the user interface 26 to disarm the alarm system or security system 20, as in 104, and the alarm sounder 24 may continue to broadcast the alarm sound at the first volume level when the control panel determines that the identified user is not attempting to use the control panel 22 or the user interface 26 to disarm the alarm system or security system 20, as in 106. However, when the control panel 22 determines that the identified user is attempting to use the control panel 22 or the user interface 26 to disarm the alarm system or security system 20, as in 108, the control panel 22 may lower the first volume level of the alarm sound broadcast by the alarm sounder 24 to a second volume level, as in 110. In some embodiments, the second volume level can be less than 90 decibels.

In some embodiments, the control panel 22 can determine that the identified user is attempting to use the control panel 22 or the user interface 26 to disarm the alarm system or security system 20 responsive to the camera or sensor 23 determining that the identified user is an authorized user of the alarm system or security system 20. Additionally or alternatively, in some embodiments, the control panel 22 can determine that the identified user is attempting to use the control panel 22 or the user interface 26 to disarm the alarm system or security system 20 responsive to detecting an initial user input to the user interface 26. Additionally or alternatively, in some embodiments, the control panel 22 can determine that the identified user is attempting to use the control panel 22 or the user interface 26 to disarm the alarm system or security system 20 responsive to detecting the identified user being within a predetermined distance of the control panel 22.

As shown in FIG. 2, after lowering the first volume level of the alarm sound broadcast by the alarm sounder 24 to the second volume level, as in 110, the control panel 22 can make a security determination and can take a specific action based on a type of the security determination, as in 112. For example, in some embodiments, the control panel 22 can make a negative security determination responsive to the alarm system or security system 20 failing to disarm within a predetermined time period following the control panel 22 determining that the identified user is attempting to use the control panel 22 to disarm the alarm system or security system 20. Additionally or alternatively, in some embodiments, the control panel 22 can make the negative security determination responsive to the control panel 22 receiving a predetermined number of failed disarm attempts. In some embodiments, the control panel 22 can make a positive security determination responsive to the control panel 22 receiving a successful disarm attempt.

In some embodiments, in response to the negative security determination, the control panel 22 can increase the second volume level of the alarm sound broadcast by the alarm sounder 24 back to the first volume level, as in 114. Furthermore, in some embodiments, the control panel 22 can lock the alarm sounder 24 at the first volume level for a predetermined period of time. It is to be understood that locking the alarm sounder 24 at the first volume level following the negative security determination can increase security because the negative security determination can indicate that it is likely that the identified user is an intruder or other potentially nefarious party. Further still in some embodiments, in response to the negative security determination, the control panel 22 can increase the second volume level broadcast by the alarm sounder 24 to a third volume level that is louder than the first volume level.

In some embodiments, in response to the positive security determination, the control panel 22 can deactivate the alarm sounder 24, as in 116.

Although a few embodiments have been described in detail above, other modifications are possible. For example, the logic flows described above do not require the particular order described or sequential order to achieve desirable results. Other steps may be provided, steps may be eliminated from the described flows, and other components may be added to or removed from the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A method comprising:
detecting an identified user at a control panel of a security system when an audio alarm is broadcasting an audio sound at a first volume level;
the control panel determining whether the identified user is attempting to use the control panel to disarm the security system;
when the control panel determines that the identified user is attempting use the control panel to disarm the security system, lowering the first volume level to a second volume level;
responsive to a negative security determination, increasing the second volume level to the first volume level; and
responsive to a positive security determination, deactivating the audio alarm.

2. The method of claim 1 wherein the control panel determines that the identified user is attempting to use the control panel to disarm the security system when the control panel determines that the identified user is an authorized user of the security system.

3. The method of claim 1 wherein the control panel determines that the identified user is attempting to use the control panel to disarm the security system when the control panel detects an initial user input to a user interface of the control panel.

4. The method of claim 1 wherein the control panel determines that the identified user is attempting to use the control panel to disarm the security system when the control panel detects the identified user within a predetermined distance of the control panel.

5. The method of claim 1 wherein the negative security determination includes the security system failing to disarm within a predetermined time period following the control panel determining that the identified user is attempting to use the control panel to disarm the security system.

6. The method of claim 1 wherein the negative security determination includes the control panel receiving a predetermined number of failed disarm attempts.

7. The method of claim 1 further comprising locking the audio alarm at the first volume level for a predetermined period of time following the negative security determination.

8. The method of claim 1 wherein the positive security determination includes the control panel receiving a successful disarm attempt.

9. The method of claim 1 wherein the control panel determines the identified user is attempting to use the control panel to disarm the security system when the control panel determines that the identified user is an authorized user of the security system, determines that the identified user is within a predetermined distance of the control panel, and detects an initial user input to a user interface of the control panel.

10. The method of claim 1 wherein the second volume level is less than 90 decibels.

11. A security system comprising:
a control panel;
a user interface of the control panel; and
an alarm sounder;
wherein the control panel detects an identified user at the control panel when the alarm sounder is broadcasting an audio alarm at a first volume level, determines whether the identified user is attempting to use the user interface to disarm the security system, and when the control panel determines that the identified user is attempting use the user interface to disarm the security system, lowers the first volume level to a second volume level,
wherein, responsive to a negative security determination, the control panel increases the second volume level to the first volume level, and
wherein, responsive to a positive security determination, the control panel deactivates the audio alarm.

12. The security system of claim 11 wherein the control panel determines that the identified user is attempting to use the user interface to disarm the security system by determining that the identified user is an authorized user of the security system.

13. The security system of claim 11 wherein the control panel determines that the identified user is attempting to use the user interface to disarm the security system by detecting an initial user input to the user interface of the control panel.

14. The security system of claim 11 wherein the control panel determines that the identified user is attempting to use the user interface to disarm the security system by detecting the identified user within a predetermined distance of the control panel.

15. The security system of claim 11 wherein the negative security determination includes the security system failing to disarm within a predetermined time period following the control panel determining that the identified user is attempting to use the user interface to disarm the security system.

16. The security system of claim 11 wherein the negative security determination includes the control panel receiving a predetermined number of failed disarm attempts.

17. The security system of claim 11 wherein the control panel locks the audio alarm at the first volume level for a predetermined period of time following the negative security determination.

18. The security system of claim 11 wherein the positive security determination includes the control panel receiving a successful disarm attempt.

19. The security system of claim 11 wherein the control panel determines that the identified user is attempting to use the user interface to disarm the security system by determining that the identified user is an authorized user of the security system, by determining that the identified user is within a predetermined distance of the control panel, and by detecting an initial user input to the user interface of the control panel.

20. The method of claim 1 wherein the second volume level is less than 90 decibels.
